(19) United States
(12) Patent Application Publication
(10) Pub. No.: US 2020/0240778 A1
(43) Pub. Date: Jul. 30, 2020

(54) MOTION MEASUREMENT METHOD AND MOTION MEASUREMENT SYSTEM

(71) Applicant: LEI & SO Co., Ltd., Kaohsiung City (TW)

(72) Inventor: Wei-Tai LEI, Hsinchu City (TW)

(21) Appl. No.: 16/748,822

(22) Filed: Jan. 22, 2020

(30) Foreign Application Priority Data
Jan. 28, 2019 (TW) 108103151

(51) Int. Cl. G01B 21/00

(52) U.S. Cl. CPC G01B 21/00

(57) ABSTRACT

A motion measurement method includes a motion measurement point defining step, a reference ball socket positioning step, a measuring bar installing step and a measuring step. A first reference point and a second reference point are disposed on the worktable. A motion measurement point is disposed on a machine spindle. A first measuring bar is installed between the first reference point and the motion measurement point. A second measuring bar is installed between the second reference point and the motion measurement point. The motion measurement point is moved relative to the first reference point and the second reference point. The motion trajectory and the motion trajectory errors of the machine can be calculated from a first measuring distance and a second measuring distance obtained by the first and the second measuring bar, in association with a first reference distance between the first and the second reference point.

### RELATED APPLICATIONS

This application claims priority to Taiwan Application Serial Number 108103151, filed Jan. 28, 2019, which is herein incorporated by reference.

### BACKGROUND

### Technical Field

The present disclosure relates to a measurement method and a measurement system. More particularly, the present disclosure relates to a motion measurement method and a motion measurement system for measuring a motion trajectory of a machine.

### Description of Related Art

In general, the controller of a precision machine generates control signals to drive its motors according to the input path command, so that the tool of the precision machine, e.g., the cutter, is driven relative to the workpiece fixed on the worktable. The elements and assemblies of the precision machine have geometric errors during the manufacturing and after the assembly. The dynamic characteristics of the driving motors are also limited and affected by external disturbances. All these factors cause geometric errors and dynamic motion errors between the tool and the workpiece. Hence, it is desired to find a proper measurement equipment and methods to measure the motion trajectory directly. The motion errors of the machine can be obtained after analyzing the measured data and the machine's accuracy can be improved by using a proper method.

The double ball bar, which indicates a measuring bar connecting to measuring balls or sockets on two ends thereof, is a common measuring device commonly used for the measurement of dynamic motion trajectory of a machine tool. To perform a circular test according to the standard of ISO 230-4, a central rod is installed onto the main spindle of the tested machine first, which has a magnetic socket at its end. Then a central ball is mounted on the worktable with the help of the central rod and is defined as the center of a test circle. Subsequently, the central rod is moved to a start point outside the test circle. After the double ball bar is installed, the two tested linear axes are driven along the test circle. The diameter deviations during the circular tracking are registered and analyzed to obtain the geometric and dynamic errors of the machine, including backlashes, squareness errors, quadrant glitches and gain mismatches. Moreover, the error compensating parameters and the servo control parameters of the controller can be adjusted to improve the performance of the machine.

The geometric and dynamic errors of a machine during the circular test are in a range of several hundred microns. The conventional double ball bar uses a linear variable differential transformer (LVDT) as displacement sensor. Since the measuring range of the conventional double ball bar is within ±2 mm, the diameter of the tested circle thereof is limited. The conventional double ball bar cannot be used to measure a circular motion of arbitrary diameter, and the diameter of the test circle is limited to some specific values such as 50 mm, 100 mm, 150 mm, and 300 mm. Specially, a circular motion of diameter smaller than 20 mm cannot be measured by the conventional double ball bar. Moreover, the conventional double ball bar cannot be used to measure a combination of paths of any type, such as a square path with non-continuous corners, to obtain dynamic errors at the corners.

In order to increase the measuring range of a double ball bar, a double ball bar employing a laser interferometer as the displacement sensor was developed in the past. Also, a double ball bar employing an optical scale as the displacement sensor was developed.

Regarding all measuring devices used in the measurement technique of a precision machine, the laser interferometer has advantages of large measuring range and high accuracy. However, the laser interferometer can only be used to measure the positioning and dynamic errors of a worktable in a linear movement. In contrast, the grid encoder is used to measure motion errors in a random path combination within a small range, but it has disadvantages of high price and difficulty in installation. In addition, the scanning head and optical disk of the grid encoder have to be adjusted to locate at a required direction and to contain a required gap. The test has to be conducted carefully to prevent a collision of the scanning head with the optical disk caused by maloperation. Although the laser double ball bar has larger measuring range, the usage thereof is still restricted to one dimensional measurement, as does the LDVT double ball bar. And the laser double ball bar has the disadvantage of high price.

During the manufacture of phone panels, round, squared or curved holes are to be cut from the hard and brittle glass or ceramic material. These holes are used to install lens, speakers or microphones. The radius of these holes is for example smaller than 5 mm. Because the cutting result affects the optical appearance, high quality manufacturing is required. When the machine is moving along a circular path, glitch errors occur at the quadrant changes. The glitch error is a dynamic phenomenon caused by an interaction between backlashes, frictional forces and motor drives at the place of quadrant change. This phenomenon may result in tool marks on the surface of the workpiece. If tool marks are seen in the projection light, the product quality is not acceptable.

Hence, in order to eliminate the quadrant glitch, the servo control parameters in the controller for the compensation of the frictional force have to be adjusted optimally. For example, optimal servo control parameters can be obtained by using artificial intelligence. However, the conventional measuring equipment for circular test cannot be used for tracking a hole of small diameter, and cannot provide real time measurement data.

Based on the aforementioned problems, how to provide a motion measurement method and system thereof for performing the circular test for holes of small diameter to assist the intelligent controller of the machine in adjusting the servo control parameters becomes a pursuit target for the practitioners.

### SUMMARY

One aspect of the present disclosure is to provide a motion measurement method applied to measure a motion trajectory of a machine. The motion measurement method includes a motion measurement point defining step, a reference socket mounting step, a measuring bar installing step and a motion measuring step. In the motion measurement point defining step, a central rod is installed on a main spindle of the machine. One end of the central rod is connected to a central ball, and a motion measurement point is defined at a center of the central ball. In the reference socket mounting step, a first reference socket and a second reference socket are mounted on a worktable of the machine. In the measuring bar installing step, a first measuring ball is attached to a first measuring bar and the first reference socket and the central ball are connected with the first measuring bar. A second measuring ball is attached to a second measuring bar and the second reference socket and the central ball are connected with the second measuring bar. In the motion measuring step, a first reference point is defined at a center of the first measuring ball, and a second reference point is defined at a center of the second measuring ball. The central ball connected to the central rod is driven by the machine such that each of the first measuring bar and the second measuring bar is extended or shortened, and a coordinate of the motion measurement point and the motion trajectory of the machine are obtained according to a first measuring distance between the first reference point and the motion measurement point measured by the first measuring bar, and a second measuring distance between the second reference point and the motion measurement point measured by the second measuring bar, in association with a first reference distance between the first reference point and the second reference point.

Another aspect of the present disclosure is to provide a motion measurement system applied to measure a motion trajectory of a machine.

The motion measurement system includes a central rod, a central ball, a first reference socket, a second reference socket, a first measuring ball, a second measuring ball, a first measuring bar and a second measuring bar. The central rod is installed on a main spindle of the machine. The central ball is connected to one end of the central rod, and a center of the central ball is defined as a motion measurement point. The first reference socket and the second reference socket are mounted on a worktable of the machine. The first measuring ball is attached to the first reference socket, and a first reference point is defined at a center of the first measuring ball. The second measuring ball is attached to the second reference socket, and a second reference point is defined at a center of the second measuring ball. The first measuring bar is connected between the first measuring ball and the central ball. The second measuring bar is connected between the second measuring ball and the central ball. The central ball connected to the central rod is driven by the machine such that each of the first measuring bar and the second measuring bar is extended or shortened, and a coordinate of the motion measurement point and the motion trajectory of the machine are obtained according to a first measuring distance between the first reference point and the motion measurement point measured by the first measuring bar, and a second measuring distance between the second reference point and the motion measurement point measured by the second measuring bar, in association with a first reference distance between the first reference point and the second reference point.

### BRIEF DESCRIPTION OF THE DRAWINGS

The disclosure can be more fully understood by reading the following detailed description of the embodiments, with reference made to the accompanying drawings as follows:

FIG. 1 is a schematic view showing a motion measurement system according to one embodiment of the present disclosure applied to a machine.

FIG. 2 is an enlarged view showing the motion measurement system of FIG. 1.

FIG. 3 is a schematic view showing a second measuring bar and a transverse member of the motion measurement system of FIG. 1.

FIG. 4 is a schematic view showing a motion measurement method according to another embodiment of the present disclosure.

FIG. 5 is a three dimensional schematic view showing a calibrating board used in the motion measurement method of FIG. 4.

FIG. 6 is a schematic view showing a reference distance measuring step of the motion measurement method of FIG. 4.

FIG. 7 is a schematic view showing a test path of the motion measurement method of FIG. 4.

### DETAILED DESCRIPTION

It will be understood that when an element (or a mechanism or a module) is referred to as be “disposed on”, “connected to” or “coupled to” another element, it can be directly disposed on, connected or coupled to the other elements, or it can be indirectly disposed on, connected or coupled to the other elements, that is, intervening elements may be present. In contrast, when an element is referred to as be “directly disposed on”, “directly connected to” or “directly coupled to” another element, there are no intervening elements present.

In addition, the terms first, second, third, etc. is used herein to describe various elements or components, these elements or components should not be limited by these terms. Consequently, a first element or component discussed below could be termed a second element or component.

In the present disclosure, a measuring bar is defined as a measuring structure with a displacement sensor. In one embodiment, one end of the measuring bar is connected to a socket. The socket which is configured to allow a central ball or a measuring ball to directly connect thereto includes a magnet therewithin. In another embodiment, one end of the measuring bar is directly connected to the central ball or the measuring ball. In yet another embodiment, one end of the measuring ball is directly connected to an extension bar, and the extension bar has a socket configured to allow the measuring ball to directly connect thereon, or the extension bar is configured to allow the measuring ball to directly connect to one end thereof. During motion trajectory measurement, two ends of the measuring bar may directly or indirectly connect to the measuring ball or the central ball; hence, the term “measuring length” is defined as a distance between centers of the measuring ball and/or the central ball connected to the two ends of the measuring bar. Moreover, if a transverse member or the extension bar is connected to the measuring bar, the measuring length includes the lengths of the transverse member and/or the extension bar.

Therefore, when the measuring bar extends to its farthest point, a maximal measuring length can be obtained, and when the measuring bar shortens to its shortest point, a minimal measuring length can be obtained. There are at least two measuring bars and at least two measuring balls used in the present disclosure; thus, in order to clarify, the terms “first measuring bar”, “the second measuring bar”, “the first measuring ball”, “the second measuring ball”, etc. are used to describe a specific measuring bar and a specific measuring ball when mentioned. On the contrary, when there has no necessary to mention a specific measuring bar and a specific measuring ball, the term “measuring bar” and “measuring ball” are used, and the present disclosure is not limited thereto.

Principle of triangulation is used in the motion measurement method of the present disclosure. Consequently, in order to measure the motion trajectory of the machine, a first reference point and a second reference point are defined on the worktable. A motion measurement point is defined on the main spindle of the machine. A first measuring bar can be installed between the first reference point and the motion measurement point, and a second measuring bar can be installed between the second reference point and the motion measurement point. Both of the first measuring bar and the second measuring bar are connected to a central ball, and the center of the central ball is served as the motion measurement point. When a test file is executed, the motion measurement point is driven relative to the first reference point and the second reference point. A coordinate of the motion measurement point can be obtained according to a first measuring distance between the first reference point and the motion measurement point measured by the first measuring bar, a second measuring distance between the second reference point and the motion measurement point measured by the second measuring bar, and a first reference distance between the first reference point and the second reference point. The motion trajectory of the machine can be obtained via the coordinates of the motion measurement point, and errors thereof can also be obtained.

The motion measurement point, the first reference point and the second reference point are all defined at the center of a ball. Hence, elements such as sockets, measuring balls or central balls can be connected to ends of the first measuring bar and the second measuring bar used in the motion measuring method. During measuring process, required elements can be connected based on requirements. In one embodiment, the displacement sensor of the first measuring bar can be a linear optical scale, a magnetic scale, a laser interferometer or a linear variable differential transformer, and the displacement sensor of the second measuring bar can be a linear optical scale, a magnetic scale, a laser interferometer or a linear variable differential transformer. Each of the displacement sensors can be a relative type sensor or an absolute type sensor.

In the motion measurement method, a central rod can be installed on the main spindle of the machine. One end of the central rod is connected to a central ball, and the center of the central ball is defined as the motion measurement point. In addition, a first base and a second base can be secured on the worktable of the machine by the central rod. The first base is configured with a first core rod and a first reference socket to be disposed thereon, and the first reference socket can be connected to one end of the first core rod. The second base is configured with a second core rod and a second reference socket to be disposed thereon, and the second reference socket can be connected to one end of the second core rod. Please be noted that, when a first measuring ball is attached to the first reference socket, the center of the first measuring ball serves as the first reference point, and when a second measuring ball is attached to the second reference socket, the center of the second measuring ball serves as the second reference point.

In another embodiment, the central rod may include a central socket, and a central ball can be attached on the central socket, which can be used to define a first reference point and a second reference point on the worktable of the machine. During the motion trajectory measurement, a first measuring bar is used to measure the distance between the motion measurement point and the first reference point, and a second measuring bar is used to measure the distance between the motion measurement point and the second reference point. In other words, the central ball attached to the end of the central rod can be connected by both of the first measuring bar and the second measuring bar.

In one embodiment, the first measuring bar and the second measuring bar are arranged in an X-axis direction and a Y-axis direction, respectively. Connection of the motion measurement point, the first reference point and the second reference point substantially forms a right triangle. A line between the first reference point and the second reference point can be served as the hypotenuse of the right triangle.

In one embodiment, the first reference distance between the first reference point and the second reference point exceeds the maximal measuring length of the first measuring bar and the maximal measuring length of the second measuring bar, and in order to measure the first reference distance, an extension bar is provided to connect to one of the first measuring bar and the second measuring bar to enlarge the measuring range thereof so as to measure the first reference distance. In another embodiment, the maximal measuring length of at least one of the first measuring bar and the second measuring bar is large enough, and the first reference distance can be measured without connection of the extension bar. In one embodiment, connection of the motion measurement point, the first reference point and the second reference point forms a regular triangle, and the first reference distance can be measured without connection of the extension bar.

Before measuring the motion trajectory, the length of the first measuring bar and the length of the second measuring bar have to be initialized. Please be noted that, the initialization of the length of a measuring bar is to connect two measuring balls (or one central ball and one measuring ball) to the two ends of the measuring bar, and to dispose the two measuring balls to two magnetic sockets on a calibrating board, respectively. The central distance between the two magnetic sockets is already known. Therefore, the relationship between the central distance of the two measuring balls and the read value of the displacement sensor of the measuring bar can be established. In addition, if there is a need for the measuring bar to connect to a transverse member or an extension bar during measurement, the initialization procedure is started after the measuring bar has connected to the transverse member or the extension bar.

In one embodiment, in order to initialize the length of the first measuring bar and the length of the second measuring bar, a calibrating board including a plurality of magnetic sockets with known central distances is provided. Each of the magnetic sockets has a magnetic socket structure providing three-point support for the attached measuring ball or central ball. After the measuring ball or the central ball is attached to the magnetic socket, a plane is formed by the three contact points, and a socket direction can be defined as the normal of the plane, and the known central distance between the two sockets is deemed as the distance between the two centers of the two measuring balls attached thereto.

In one embodiment, the magnetic sockets of the calibrating board are accurately manufactured, and the central distance between two specific magnetic sockets is known. When the first measuring bar or the second measuring bar is connected to two measuring balls, or one central ball and one measuring ball, which can be disposed at two magnetic sockets of the calibrating board, for the initialization of the length thereof, since the measuring direction is substantially perpendicular to the socket direction, positions of the centers may change along the socket direction as the diameter of the measuring ball or the diameter of the central ball is varied. However, the distance variation between the two measuring balls, or one central ball and one measuring ball, can be ignored as long as the diameter variation is small. In other words, the known central distance between two specific magnetic sockets will not be affected by the diameter variation of the attached measuring ball or the central ball. In other embodiment, if the diameter difference between two measuring balls attached to the measuring bar is known, the initialized length can be calibrated by the diameter difference, or the first measuring distance and the second measuring distance may be compensated after measurement.

In one embodiment, one end of the first measuring bar or one end of the second measuring bar can be connected to a socket which includes three-point support and its socket direction is parallel to the measuring direction of the first measuring bar or the measuring direction of the second measuring bar. To enable the initialization, a measuring ball can be attached to the socket of the first measuring bar or the second measuring bar, and, after the initialization, the measuring ball will be separated from the socket. Another measuring ball will be attached to the socket which is connected to the first measuring bar or the second measuring bar for motion trajectory measurement. The diameter of the measuring ball used for motion trajectory measurement has to be equal to the diameter of the measuring ball used for initialization, otherwise the diameter difference will produce a measurement error. In order to maintain the accuracy of the measurement, steps of the motion measurement method has to be properly arranged, and the diameter of the measuring ball attached to the socket which is connected to the measuring bar has to be well controlled. The measuring distance obtained by the first measuring bar or the second measuring bar has to be compensated by the diameter variation of the measuring ball or the central ball connected thereto if necessary.

In the present disclosure, two measuring bars are connected to the same central ball. When the central rod includes a central socket connected to one end thereof, the central ball can be defined as the measuring ball which is fixed to one end of one of the measuring bars and is attached to the central socket. The other one of the measuring bars can connect to a socket configured to allow the central ball to attach thereto. In other embodiments, the central ball can be fixed on the central rod, and each of the two measuring bars can connect to the central ball by connecting a socket which can attach to the central ball. In the present disclosure, not only do the initialization sequences for the first measuring bar and the second measuring bar have to be considered, but also the operation sequences for defining the first reference point and the second reference point and the definition of the first reference point and the second reference point have to be considered. Due to these factors, the design of steps and sequences of the motion measurement method and the choice of elements connected to the first measuring bar and the second measuring bar become very complex. It is better that, in the motion measurement method, no extra measuring bar is used, which facilitates a decrease in cost.

In one embodiment of the present disclosure, a central ball is fixed to one end of the central rod, and the central ball is connected by both the first measuring bar and the second measuring bar during motion trajectory measurement. One end of the first measuring bar can be connected to a socket whose socket direction is the same as the measuring direction of the measuring bar. In order to make sure that the initialized length is valid, in the initialization, the central ball connected by the central rod is connected to the socket connected by the first measuring bar in advance. The first measuring bar can be disposed on the calibrating board to initialize the length, and then the central rod and the central ball can be removed from the first measuring bar so as to be disposed on the main spindle of the machine. During measurement, the first measuring bar can be connected between the central ball and the first reference socket. Since the first measuring bar connects the same central ball both in the initialization and in the motion trajectory measurement, the initialized length is valid in the motion trajectory measurement.

In one embodiment, a transverse member can be provided. The transverse member includes a transverse socket. The second measuring bar can connect to the transverse member, and a socket direction of the transverse socket is perpendicular to the measuring direction of the second measuring bar. The transverse socket can connect to a measuring ball, and after initialization of the second measuring bar, the measuring ball can be removed. The transverse socket of the transverse member can connect to the central ball during measurement. Although the diameter of the measuring ball in initialization is different from that of the central ball, the initialized length is still functional and will not affect the measured distance of the second measuring bar. In another embodiment, a known inclined angle is contained between the socket direction of the transverse socket and the measuring direction of the measuring bar. In such case, the diameter of the measuring ball used in initialization is better known, which can be used to compensate the diameter difference.

A trigger path is needed in a conventional circular test, which facilitates latter data processing. However, no trigger path is needed in the motion measurement method in the present disclosure, because the coordinate of the motion measurement point at any moment can be directly obtained by the first measuring distance, the second measuring distance and the first reference distance. The test path of the motion measurement method can include a square path, a rectangle path or a curve path to identify the dynamic errors of the machine at corners. The measurement results can be used to adjust the servo control parameters for the motors. In the motion measurement method of the present disclosure, the test path can include a path which is generated by a single linear or rotary axis. The advantage thereof is that the coordinate system of the machine can be obtained by driving a single axis and processing the measured motion measurement points. As a result, the analysis of dynamic errors and the geometric errors, including the squareness errors between axes and the positioning errors of a single driving axis, can be simplified.

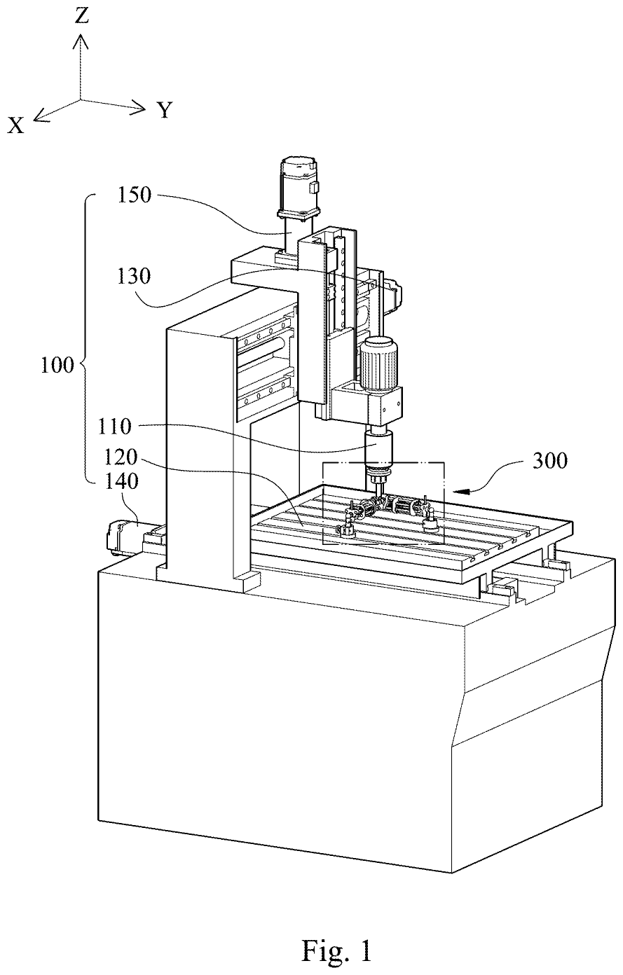

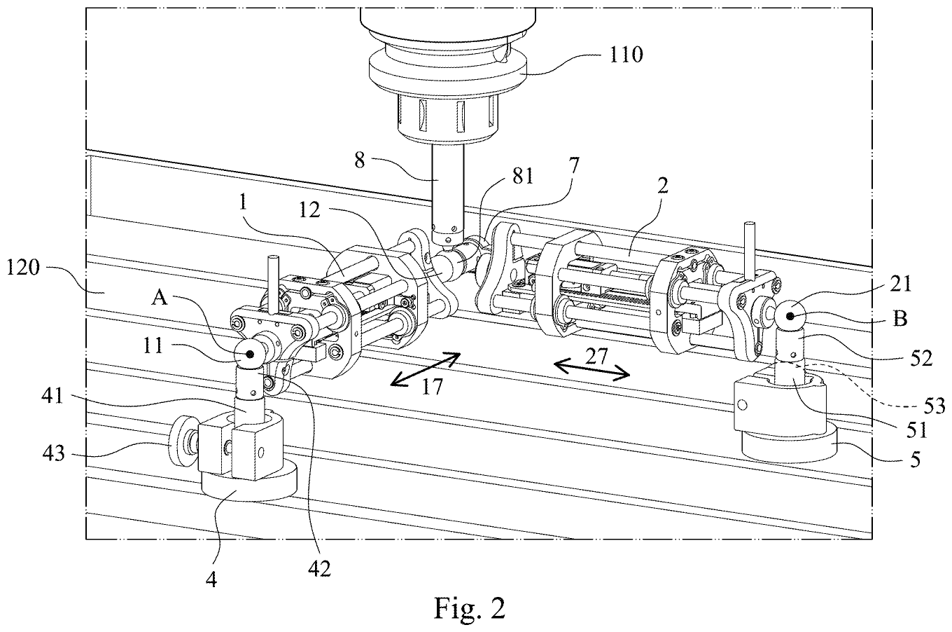

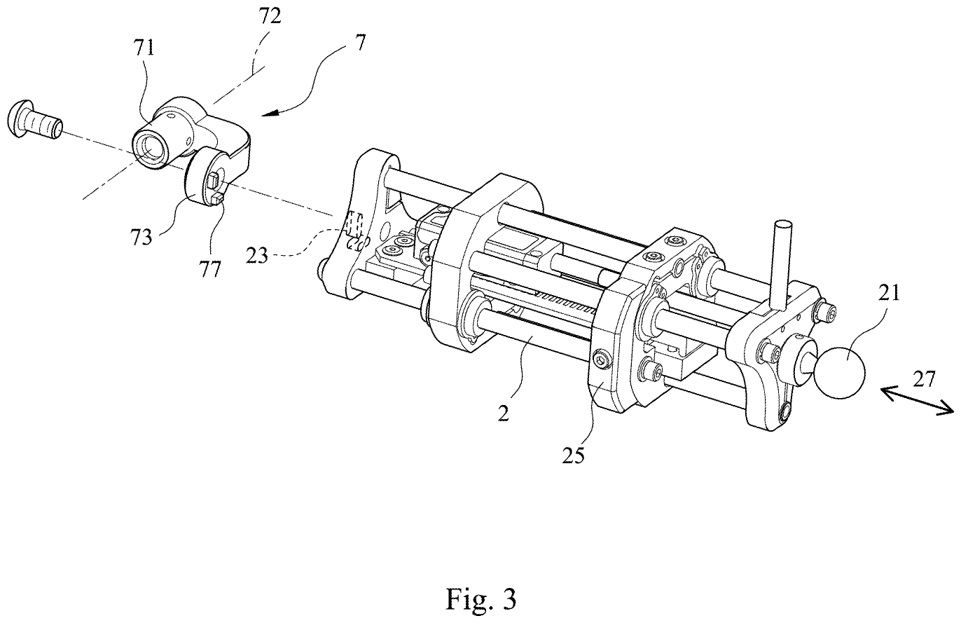

FIG. 1 is a schematic view showing a motion measurement system 300 according to one embodiment of the present disclosure applied to a machine 100. FIG. 2 is an enlarged view showing the motion measurement system 300 of FIG. 1. FIG. 3 is a schematic view showing a second measuring bar 2 and a transverse member 7 of the motion measurement system 300 of FIG. 1.

The present disclosure provides a motion measurement system 300 including a central rod 8, a central ball 81, a first reference socket 42, a second reference socket 52, a first measuring ball 11, a second measuring ball 21, a first measuring bar 1 and a second measuring bar 2. The central rod 8 is disposed on the main spindle 110 of the machine 100. The central ball 81 is connected by one end of the central rod 8, and a motion measurement point is defined at the center of the central ball 81. The first reference socket 42 and the second reference socket 52 are disposed on the worktable 120 of the machine 100. The first measuring ball 11 is attached to the first reference socket 42, and a first reference point A is defined at the center of the first measuring ball 11. The second measuring ball 21 is attached to the second reference socket 52, and a second reference point B is defined at the center of the second measuring ball 21. The first measuring bar 1 is connected between the first measuring ball 11 and the central ball 81. The second measuring bar 2 is connected between the second measuring ball 21 and the central ball 81. The central ball 81 connected by the central rod 8 is driven by the machine 100 such that each of the first measuring bar 1 and the second measuring bar 2 is extended or shortened, and a coordinate of the motion measurement point and the motion trajectory of the machine 100 are obtained according to a first measuring distance between the first reference point A and the motion measurement point B measured by the first measuring bar 1, and a second measuring distance between the second reference point B and the motion measurement point measured by the second measuring bar 2, in association with a first reference distance between the first reference point A and the second reference point B.

A motion measurement method 300 which is applied to the motion measurement system 300 will be described in detail hereafter.

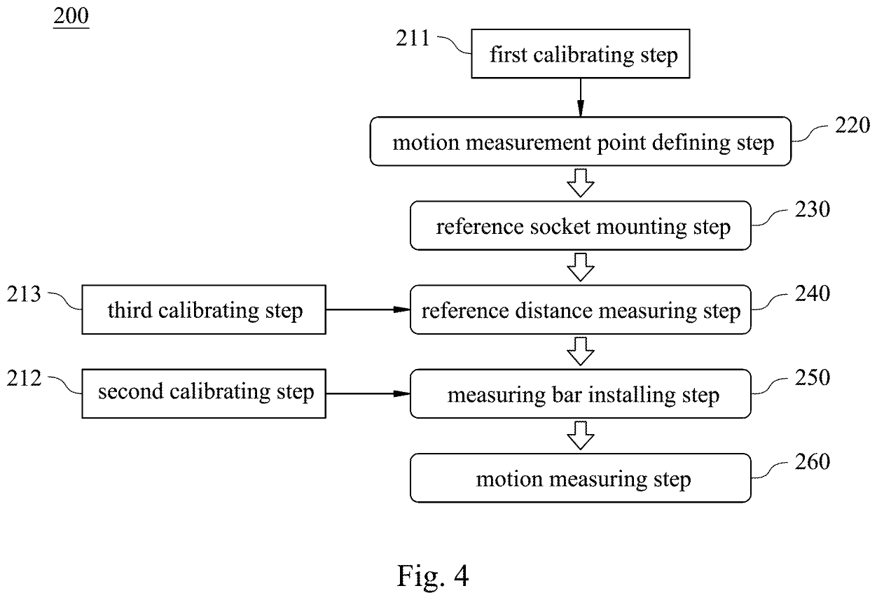

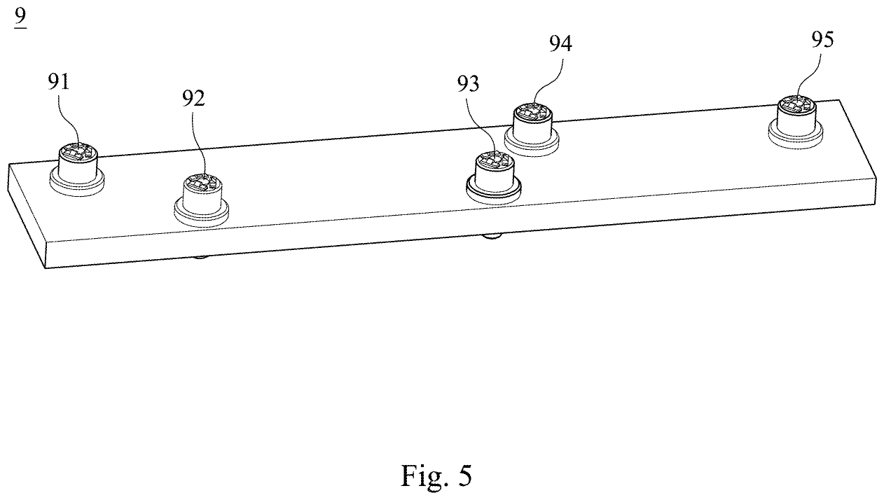

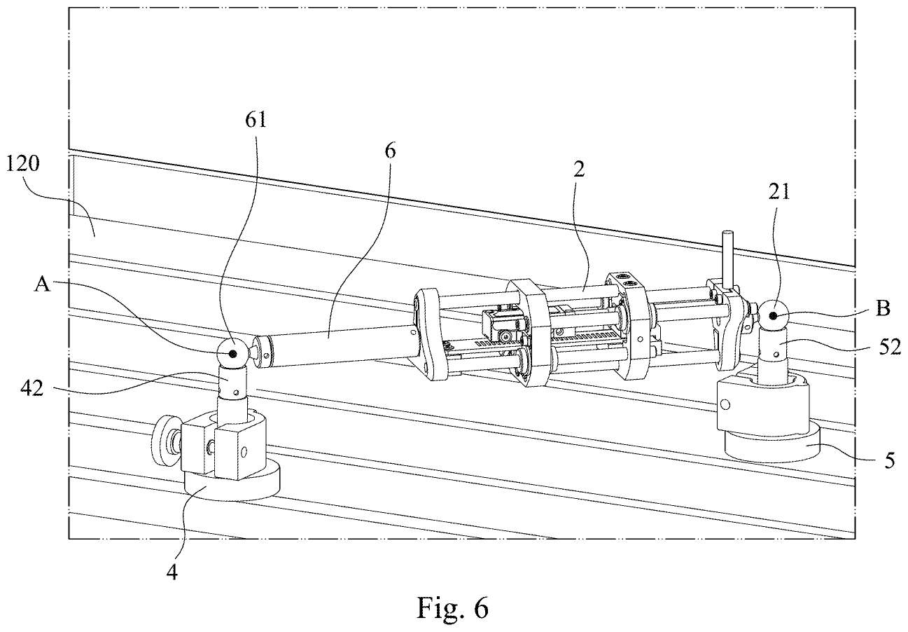

FIG. 4 is a schematic view showing a motion measurement method 200 according to another embodiment of the present disclosure. FIG. 5 is a three dimensional schematic view showing a calibrating board 9 used in the motion measurement method 200 of FIG. 4. FIG. 6 is a schematic view showing a reference distance measuring step 240 of the motion measurement method 200 of FIG. 4. Please refer to FIGS. 4 to 6 and with reference to FIGS. 1 to 3, the motion measurement method 200 includes a motion measurement point defining step 220, a reference socket mounting step 230, a reference distance measuring step 240, a measuring bar installing step 250 and a motion measuring step 260.

In the motion measurement point defining step 220, a central rod 8 is installed onto the main spindle 110 of the machine 100. One end of the central rod 8 is connected to a central ball 81, and a motion measurement point is defined at the center of the central ball 81.

In the reference socket mounting step 230, a first reference socket 42 and a second reference socket 52 are mounted on the worktable 120 of the machine 100.

In the reference distance measuring step 240, a first reference distance between the first reference socket 42 and the second reference socket 52 is measured by one of the first measuring bar 1 and the second measuring bar 2.

In the measuring bar installing step 250, a first measuring ball 11 is attached to the first reference socket 42 and a first measuring bar 1 is connected between the first measuring ball 11 and the central ball 81. A second measuring ball 21 is attached to the second reference socket 52 and a second measuring bar 2 is connected between the second measuring ball 21 and the central ball 81.

In the motion measuring step 260, a first reference point A is defined at the center of the first measuring ball 11, and a second reference point B is defined at the center of the second measuring ball 21. The central ball 81 connected by the central rod 8 is driven by the machine 100 such that each of the first measuring bar 1 and the second measuring bar 2 is extended or shortened, and a coordinate of the motion measurement point and the motion trajectory of the machine 100 are obtained according to a first measuring distance between the first reference point A and the motion measurement point measured by the first measuring bar 1 which is connected between the central ball 81 and the first measuring ball 11, and a second measuring distance between the second reference point B and the motion measurement point measured by the second measuring bar 2 which is connected between the central ball 81 and the second measuring ball 21, and a first reference distance between the first reference point A and the second reference point B.

Therefore, the motion measurement method 200 allows the machine 100 to track out a small circular path or other test path to measure the motion trajectory.

The machine 100 includes the main spindle 110, three driving axes 130, 140 and 150 and the worktable 120, and the three axes are X-axis, Y-axis and Z-axis, respectively. The motion measurement system 300 can be configured on the machine 100 to measure the motion trajectory of the machine 100.

In order to increase the measurement accuracy, the motion measurement method 200 can further include a first calibrating step 211 before executing the motion measurement point defining step 220. In the first calibrating step 211, a calibrating board 9 is provided as shown in FIG. 5. The calibrating board 9 provides a plurality of known central distances. The first measuring bar 1 is connected to the central ball 81 and the first measuring ball 11, and the length of the first measuring bar 1 is initialized by one of the known central distances.

To be more specific, one end of the first measuring bar 1 is connected to the first measuring ball 11, and the other end of the first measuring bar 1 is connected to a socket 12. One end of the central rod 8 can be fixed to the central ball 81. In other words, the central rod 8 and the central ball 81 are integrally connected.

Before executing the first calibrating step 211, the central ball 81 fixed to the central rod 8 can be attached to the socket 12 connected by the first measuring bar 1, and one of the known central distances can be used to initialize the first measuring bar 1. For example, the central ball 81 can be attached to the magnetic socket 92 first, and the first measuring ball 11 can be attached to the magnetic socket 93. Hence, the length of the first measuring bar 1 can be set to equal to the known central distance between the magnetic socket 92 and the magnetic socket 93. In other words, the relationship between the read value of the displacement sensor of the first measuring bar 1 and the distance between the central ball 81 and the first measuring ball 11 can be established.

Hence, since the central ball 81 connected by the central rod 8 is attached to the socket 12 connected by the first measuring bar 1 during motion measuring step 260, the socket direction of the socket 12 connected by the first measuring bar 1 is the same as a measuring direction 17 of the first measuring bar 1. The diameter of the central ball 81 will affect the measured length of the first measuring bar 1. Hence, in the first calibrating step 211, the central ball 81, instead of other measuring balls with other sizes, is attached to the socket 12 connected by the first measuring bar 1 to conduct the initialization, and the errors can be avoided.

After initialization of the first measuring bar 1, the central ball 81 can be removed from the socket 12 connected by the first measuring bar 1 and can be installed onto the main spindle 110 for latter steps. Please be noted that, in the embodiment, the central ball 81 will not be removed from the main spindle 110 after the central ball 81 is attached to the main spindle 110, thereby simplifying the operation and keeping the position of the central ball 81 at the Z-axis. Although in motion measuring method 200, the central ball 81 is connected to both the first measuring bar 1 and the second measuring bar 2, since the central ball 81 is installed on the main spindle 110 and will not be removed from the spindle 100 after initialization of the first measuring bar 1, the central ball 81 cannot be used for the initialization of the second measuring bar 2. Hence, other measuring balls such as a fourth measuring ball will be used.

Because both of the first measuring bar 1 and the second measuring bar 2 will connect to the same central ball 81 in the motion measuring step 260, a transverse member 7 is provided and can be connected between the central ball 81 and the second measuring bar 2. As shown in FIG. 3, the transverse member 7 can include a connecting portion 73 and a transverse socket 71. The axis of the connecting portion 73 is perpendicular to the axis 72 of the transverse socket 71. Moreover, when the transverse member 7 is connected to the second measuring bar 2, the direction of the axis of the connecting portion 73 is equal to the measuring direction 27 of the second measuring bar 2. By employment of the transverse member 7, interference between the first measuring bar 1 and the second measuring bar 2 during measurement can be avoided, which also allows the second measuring bar 2 to connect to another measuring ball, i.e., the fourth measuring ball, instead of the central ball 81 for the initialization of the second measuring bar 2.

The transverse member 7 can include at least one positioning portion 77, and the second measuring bar 2 can include at least one aligning portion 23 engaged with the positioning portion 77. Precisely, the number of the positioning portions 77 can be two and each of the positioning portions 77 can have a protrusion structure. The two positioning portions 77 are spaced from each other and can mount on the transverse member 7 in two directions. The number of the aligning portions 23 is two and each of the aligning portions 23 has a groove structure. Hence, when the transverse member 7 is fixed to the second measuring bar 2 by screws, the torque of the screw will push the transverse member 7 to the aligning portions 23 of the second measuring bar 2. Consequently, when the central ball 81 is attached to the transverse socket 71 of the transverse member 7, the center of the central ball 81 will fall on the central axis of the second measuring bar 2. In order to balance the transverse member 7, the second measuring bar 2 can include a balance block 25 which is shown in FIG. 3 but not shown in FIG. 2.

For improvement of the measurement accuracy of the motion trajectory, the motion measurement method 200 can further include a second calibrating step 212. The transverse member 7 is provided. The second measuring bar 2 can be connected between the transverse member 7 and the second measuring ball 21, and the fourth measuring ball can be connected to the transverse member 7. One of the known central distances of the calibrating board 9 can be used to initialize the length of the second measuring bar 2. Because the socket direction of the transverse socket 71 is perpendicular to the measuring direction 27 of the second measuring bar 2, the diameter of the forth measuring ball can be slightly different from the diameter of the central ball 81, and the measuring distance obtained by the second measuring bar 2 will not be affected after the second measuring bar 2 connecting to the central ball 81.

In other embodiments, the central ball and the central rod connected thereto can be installed to the main spindle of the machine after using for initialization of the second measuring ball, or, in still other embodiments, the central rod can be installed to the main spindle of the machine first, and then the central ball can be removed therefrom for initialization of the second measuring bar as long as the central ball is not integrally connected to the central rod, but the present disclosure is not limited thereto. The second calibrating step 212 can be executed before the measuring bar installing step 250, and it will not be limited by the sequence shown in FIG. 4.

After the central ball 81 is fixed on the main spindle 110, the first reference point A and the second reference point B on the worktable 120 of the machine 100 can be defined by the central ball 81, and then the central ball 81 can be positioned to the start point of the measurement. Thus, the Z-coordinate of the first reference point A, the second reference point B and the motion trajectory will be the same.

Before defining the first reference point A and the second reference point B, the first reference socket 42 and the second reference socket 52 have to be mounted. Consequently, in the reference socket mounting step 230, a first base 4 and a second base 5 are mounted on the worktable 120. A first core rod 41 and a second core rod 51 are disposed in the first base 4 and the second base 5, respectively, and the first core rod 41 and the second core rod 51 are connected to the first reference socket 42 and the second reference socket 42, respectively. The central ball 81 on the main spindle 110 is driven to allow the first reference socket 42 to attach to the central ball 81 for positioning the first reference socket 42, and to allow the second reference socket 52 to attach to the central ball 81 for positioning the second reference socket 52. To be more specific, as shown in FIG. 3, the first base 4, the first core rod 41 and the first reference socket 42 are provided. The first core rod 41 is movably disposed in the first base 4 and one end of the first core rod 41 is connected to the first reference socket 42. The first core rod 41 can be secured on the first base 4 by a first screw 43. Similarly, the second base 5, the second core rod 51 and the second reference socket 52 are provided. The second core rod 51 is movably disposed in the second base 5 and one end of the second core rod 51 is connected to the second reference socket 52. The second core rod 51 can be secured on the second base 5 by a second screw 53.

In the reference socket mounting step 230, the first base 4 can be mounted at a predetermined position on the worktable 120. The first core rod 41 can be initially fixed in the first base 4 by the first screw 43, and then the central rod 8 can be driven to a position about 1 mm to 2 mm above the first reference socket 42. Subsequently, the first screw 45 is released to allow the first reference socket 42 to attach to the central ball 81 of the central rod 8 owning to the magnetic force. Finally, the first screw 43 is fastened to secure the first core rod 41, and the mounting of the first reference socket 42 on the worktable 120 is completed. Similarly, the mounting of the second reference socket 52 on the worktable 120 can be done by the same way. The central ball 81 can then be driven to the start point of the measurement.

In other embodiments, in the reference socket mounting step, a standard board can be fixed to the worktable, and the first reference socket and the second reference socket are located on the standard board. In the case, the motion measurement method can further include a central ball positioning step. The machine can include three axes. The central ball can be driven stepwise, and the incremental distance per step is known. When the first measuring distance of the first measuring bar and the second measuring distance of the second measuring bar are not affected by the movement of the central ball, the positioning of the central ball is completed.

Precisely, a standard board is provided, and at least two sockets are located on the standard board. When the standard board is disposed on the worktable, the two sockets can be served as the first reference socket and the second reference socket, respectively. In the case, the central ball positioning step is used to position the central ball. In the central ball positioning step, the central ball is to move to a specific position by driving the non-tested axis, at which a small movement of the central ball will not affect the first measuring distance obtained by the first measuring bar and the second measuring distance obtained by the second measuring bar. For example, in measuring the motion trajectory errors of the X-axis and the Y-axis of the machine, the central ball is fixed with the non-tested Z-axis, and the central ball is to move to a specific Z-position. Ideally, when the central ball is in the specific position, a plane formed by the central ball, the first measuring ball and the second measuring ball is approximately parallel to an XY plane formed by the other two tested axes, i.e., the X-axis and the Y-axis. This specific Z-position can be found by driving the central ball stepwise. The incremental distance per step can be, but not limited to, 0.1 mm. The central ball can be driven to move 0.1 mm per step to a next position until the movement of 0.1 mm does not affect the measuring value of the first measuring bar and the measuring value of the second measuring bar.

For example, if the measuring value of the measuring bar is 150 mm. The hypotenuse of a right triangle formed by two sides of the lengths 150 mm and 0.1 mm is equal to 150.000033 mm. Hence, when the resolution of the measuring bar is 0.00005 mm, an incremental movement of 0.1 mm will not affect the measuring value of the measuring bar. The standard board is made of a material whose coefficient of thermal expansion is substantially zero. The central distance between the first reference socket and the second reference socket is known and not affected by a change of the ambient temperature so that the reference distance measuring step can be omitted.

In the measuring bar installing step 250, the first measuring ball 11 connected by the first measuring bar 1 can be positioned at the first reference socket 42, and the socket 12 connected by the first measuring bar 1 can be attached to the central ball 81. The second measuring ball 21 connected by the second measuring bar 2 can be positioned at the second reference socket 52, and the transverse socket 71 of the transverse member 71 connected by the second measuring bar 2 can be attached to the central ball 81 to complete the installation of the first measuring bar 1 and the second measuring bar 2. The first reference point A and the second reference point B can be defined as the center of the first measuring ball 11 and the center of the second measuring ball 21, respectively.

FIG. 6 is a schematic view showing a reference distance measuring step 240 of the motion measurement method 200 of FIG. 4. As shown in FIG. 6, in the reference distance measuring step 240, an extension bar 6 is provided. A fourth measuring ball 61 connected by the extension bar 6 is allowed to attach to the first reference socket 42. The second measuring ball 21 is attached to the second reference socket 52, and the second measuring bar 2 is connected between the extension bar 6 and the second measuring ball 21 to measure the first reference distance.

To be more specific, when the size of the worktable 120 of the machine 100 is limited, the maximal measuring lengths of the first measuring bar 1 and the second measuring bar 2 have to be restricted such that the first measuring bar 1 and the second measuring bar 2 can be disposed on the worktable 120. If the measuring ranges of the first measuring bar 1 and the second measuring bar 2 are not enough for measuring the first reference distance between the first reference point A and the second reference point B, the second measuring bar 2 can be connected to an extension bar 6 which can be connected by the fourth measuring ball 61.

The motion measurement method 200 can further include a third calibrating step 213, and one of the known central distances of the calibrating board 9 can be used to initialize the length of the second measuring bar 2 with the extension bar 6. The third calibrating step 213 can be executed before the reference distance measuring step 240, or before the second calibrating step 212. Because the second measuring bar 2 will be separated from the extension bar 6 and be connected to the transverse member 7 after execution of the reference distance measuring step 240, the initialization of the second measuring bar 2 with the transverse member 7 should be executed after the third calibrating step 213.

Since the distance between the first reference point A and the second reference point B will fall within the measuring range of the second measuring bar 2 with the extension bar 6, the first reference distance between the first reference point A and the reference point B can be obtained.

In other embodiments, the measuring bar has a maximal measuring length L21 and a minimal measuring length L22. L21 is better to be large than \sqrt{2}× L22. In such situation, the measuring range of the second measuring bar is large enough to directly measure the first reference distance between the first reference point and the second reference point without connecting to the extension bar to shift the measuring range of the second measuring bar.

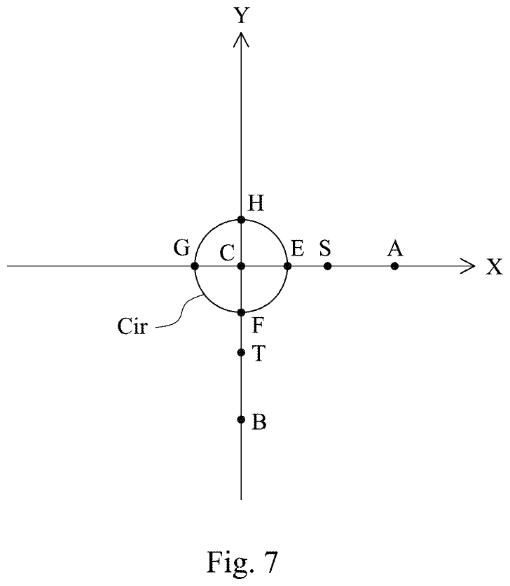

As shown in FIGS. 2 and 7, the first reference point A and the second reference point B can be arranged in the X-axis and the Y-axis, respectively. In other embodiments, the first measuring bar or the second measuring bar can directly measure the first reference distance between the first reference point and the second reference point, and connection of the motion measurement point, the first reference point and the second reference point can substantially form a regular triangle.

FIG. 7 is a schematic view showing a test path for the motion measurement method 200 of FIG. 4. The test path shown in FIG. 7 is used for a circular test and includes a test circle Cir with a radius of 5 mm including the following parameters: a start point S(10, 0), an entering point E(5, 0), an exit point F(0, −5) and a stop point T(0, −10). The test circle Cir has a center C(0, 0). The coordinate of the first reference point A is (167.7, 0). The coordinate of the second reference point B is (0, −167.7). The first reference distance between the first reference point A and the second reference point B, i.e., the hypotenuse, is equal to 237.2 mm. The first reference distance can be obtained by the reference distance measuring step 240. Since the maximal measuring length of each of the first measuring bar 1 and the second measuring bar 2 is equal to 186.7 mm, and the minimal measuring length of each of the first measuring bar 1 and the second measuring bar 2 is equal to 148.7 mm, the second measuring bar 2 cannot be used to measure the first reference distance (about 237.2 mm) directly. Hence, the extension bar 6, having a length of 84.0 mm, can be connected to the second measuring bar 2 to shift the measuring range of the second measuring bar 2 from 232.7 mm to 270.07 mm for the measurement of the first reference distance between the first reference point A and the second reference point B.

The calibrating board 9 is made of ZERODUR®, the coefficient of thermal expansion thereof is substantially zero. The calibrating board 9 is used to initialize the length of each of the first measuring bar 1 and the second measuring bar 2.

As shown in FIG. 5, four known central distances and five magnetic sockets 91, 92, 93, 94 and 95 are provided by the calibrating board 9. The known central distance between the magnetic sockets 92 and 93, the magnetic sockets 93 and 95, the magnetic sockets 92 and 94, the magnetic sockets 91 and 94, is about 150 mm, 165.74 mm, 185.25 mm and 234.52 mm, respectively. Hence, during initialization of the first measuring bar 1 and the second measuring bar 2, three known central distances can be used to establish three calibration points. For example, 150 mm, 165.75 mm and 185.52 mm are used to establish the three calibration points, and the relation between the measuring distance of the measuring bar and the read value thereof can be obtained.

In motion measuring step 260, the test motion will start from the start point S to the entering point E, and then move to the stop point T through the exit point F after one and three-fourth turns of the test circle Cir in a counter clockwise direction. Subsequently, motion measurement in clockwise direction can be conducted, the motion measurement point will start from the stop point T to the exit point F, and then move to the start point S through the entering point E after one and three-fourth turns of the test circle Cir in the clockwise direction. In the counter clockwise direction test or clockwise direction test, the movement between the start point S and the entering point E is driven by the X-axis, and the movement between the exit point F and the stop point T is driven by the Y-axis. The start point S and the stop point T can be set in or out of on the test circle Cir. For example, the point G can be served as the start point, and the point H can be served as the stop point.

In other embodiments, the test path can be a straight path, a circular path, or a curved path in the motion measuring step. The test axis of the machine can be a linear axis or a rotating axis. The test path can be a specific path and the motion measurement point can be generated by driving a single axis to follow the specific path.

The motion measurement method can be expanded to measure a 3D motion trajectory of the machine. Hence, for other embodiments, a third socket can be defined on the worktable of the machine in the reference socket mounting step. In the reference distance measuring step, a third measuring bar can be provided, and at least one of the first measuring bar, the second measuring bar and the third measuring bar is used to measure a second reference distance between the first reference socket and the third reference socket, and to measure a third reference socket between the second reference socket and the third reference socket. In the measuring bar installing step, a third measuring ball can be attached to the third reference socket, and the third measuring bar is connected between the third measuring ball the central ball. In the motion measuring step, a third reference point is defined at the center of the third measuring ball. The central ball connected by the central rod is driven by the machine such that the three measuring bars are extended or shortened, and the coordinate of the motion measurement point and the motion trajectory of the machine are obtained according to the first measuring distance, the second measuring distance and the third measuring distance, in association with the first reference distance, the second reference distance and the third reference distance.

Furthermore, in other embodiments, the motion measurement system can also be expended. A third reference socket can be mounted on the worktable of the machine. A third measuring ball can be attached to the third reference socket, and a third reference point is defined at a center of the third measuring ball. A third measuring bar can be connected between the third reference socket and the central ball, and the coordinate of the motion measurement point and the motion trajectory of the machine can be obtained according to three measuring distances between the three reference points and the motion measurement point measured by the three measuring bars which are connected between the central ball and the three measuring balls, in association with the first reference distance, the second reference distance and the third reference distance.

In the measurement of the 3D motion trajectory, the central ball will be connected by three measuring bars, and interference between the three measuring bars during measurement has to be avoided. In one embodiment, the diameter of the central ball connected by one end of the central rod is large enough such that all of the sockets connected by the first measuring bar, the second measuring bar and the third measuring bar, respectively, can attach to the central ball. In other embodiments, the central rod can include a central socket. For example, the first measuring bar can connect to a first measuring ball with large diameter configured to attach to the central socket for severing as a central ball.

In the embodiment of FIGS. 1 to 7, the first measuring bar 1 uses a linear optical scale configured to measure the displacement, and the second measuring bar 2 also uses a linear optical scale configured to measure the displacement. In other embodiments, the first measuring bar can use a linear optical scale, a magnetic scale, a laser interferometer or a linear variable differential transformer, and the second measuring bar can use a linear optical scale, a magnetic scale, a laser interferometer or a linear variable differential transformer. The socket can include three-point support for bearing the measuring ball, or can include a curved support. The socket can use three spheres, three planes or others to create the three supporting points. The number of the known central distances can be modified according to demands. The test axis of the machine can be a linear or a rotary axis. The number of the reference points, the defining method of the reference points, and the sequence of the steps can also be modified. In addition, the test path can be a combination of lines, circles and curves. The machine can be a machine tool, a computer controlled machine or a robotic arm.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A motion measurement method, which is applied to measure a motion trajectory of a machine, comprising:
a motion measurement point defining step, wherein a central rod is installed onto a main spindle of the machine, one end of the central rod is connected to a central ball, and a motion measurement point is defined at a center of the central ball;
a reference socket mounting step, wherein a first reference socket and a second reference socket are mounted on a worktable of the machine;
a measuring bar installing step, comprising:
attaching a first measuring ball to a first measuring bar and connecting the first reference socket and the central ball with the first measuring bar; and
attaching a second measuring ball to a second measuring bar and connecting the second reference socket and the central ball with the second measuring bar; and
a motion measuring step, wherein a first reference point is defined at a center of the first measuring ball, a second reference point is defined at a center of the second measuring ball, the central ball connected by the central rod is driven by the machine such that each of the first measuring bar and the second measuring bar is extended or shortened, and a coordinate of the motion measurement point and the motion trajectory of the machine are obtained according to a first measuring distance between the first reference point and the motion measurement point measured by the first measuring bar which is connected between the central ball and the first measuring ball, and a second measuring distance between the second reference point and the motion measurement point measured by the second measuring bar which is connected between the central ball and the second measuring ball, in association with a first reference distance between the first reference point and the second reference point.

2. The motion measurement method of claim 1, further comprising a first calibrating step, wherein a calibrating board is provided, the calibrating board includes a plurality of magnetic sockets and a plurality of known central distances, the first measuring bar is connected to the central ball and the first measuring ball, and a length of the first measuring bar is initialized by one of the known central distances.

3. The motion measurement method of claim 2, further comprising a second calibrating step, wherein a transverse member is provided, the second measuring bar is connected to the transverse member and the second measuring ball, the transverse member is connected to a fourth measuring ball, and a length of the second measuring bar is initialized by one of the known central distances.

4. The motion measurement method of claim 2, wherein the central rod is integrally connected to the central ball, the first calibrating step is executed to initialize the length of the first measuring bar after the first measuring bar is connected between the central ball and the first measuring ball, and then the motion measurement point defining step is executed to separate the central rod from the first measuring bar and to install the central rod onto the main spindle of the machine.

5. The motion measurement method of claim 1, wherein, in the motion measuring step, the motion measurement point is driven according to a test path comprising at least one straight path, at least one circular path, or at least one curved path.

6. The motion measurement method of claim 1, wherein the machine comprises a plurality of driving axes, and the motion measurement point is driven by one of the driving axes.

7. The motion measurement method of claim 6, wherein a machine axis coordinate system and errors thereof are obtained by measuring results of the motion measurement points driven by one of the driving axes.

8. The motion measurement method of claim 1, further comprising:
a reference distance measuring step, wherein the first reference distance between the first reference socket and the second reference socket is measured by one of the first measuring bar and the second measuring bar.

9. The motion measurement method of claim 8, wherein, in the reference distance measuring step, a transverse member and a fourth measuring ball are provided, the fourth measuring ball is attached to the first reference socket and the transverse member, the second measuring ball is attached to the second reference socket, and the first reference distance is measured by the second measuring bar which is connected to the transverse member and the second measuring ball.

10. The motion measurement method of claim 8, wherein, in the reference distance measuring step, an extension bar and a fourth measuring ball are provided, the fourth measuring ball is attached to the first reference socket and is connected to the extension bar, the second measuring ball is attached to the second reference socket, and the first reference distance is measured by the second measuring bar which is connected to the extension bar and the second measuring ball.

11. The motion measurement method of claim 10, wherein, in the motion measuring step, a diameter deviation between the fourth measuring ball and the central ball is used to compensate the second measuring distance.

12. The motion measurement method of claim 8, wherein,
in the reference socket mounting step, a third socket is mounted on the worktable of the machine;
in the reference distance measuring step, a third measuring bar is provided, at least one of the first measuring bar, the second measuring bar and the third measuring bar is used to measure a second reference distance between the first reference socket and the third reference socket, and to measure a third reference distance between the second reference socket and the third reference socket;
in the measuring bar installing step, a third measuring ball is attached to the third reference socket, and the third measuring bar is connected between the third measuring ball and the central ball; and
in the motion measuring step, a third reference point is defined at a center of the third measuring ball, the central ball connected by the central rod is driven by the machine such that the third measuring bar is extended or shortened, and the coordinate of the motion measurement point and the motion trajectory of the machine are obtained according to the first measuring distance, the second measuring distance and the third measuring distance, in association with the first reference distance, the second reference distance and the third reference distance.

13. The motion measurement method of claim 1, wherein, in the reference socket mounting step, a first base and a second base are provided on the worktable, a first core rod and a second core rod are disposed in the first base and the second base, respectively, the first core rod and the second core rod are connected to the first reference socket and the second reference socket, respectively, and the central ball on the main spindle is driven to attach the first reference socket for positioning the first reference socket and to attach the second reference socket for positioning the second reference socket.

14. The motion measurement method of claim 1, wherein, in the reference socket mounting step, a standard board is fixed on the worktable, and the first reference socket and the second reference socket are located on the standard board.

15. The motion measurement method of claim 14, further comprising:
a central ball positioning step, wherein the machine comprising three axes, the central ball is to move to a specific position by driving one of the three axis, at which a small movement of the central ball does not affect the first measuring distance obtained by the first measuring bar and the second measuring distance obtained by the second measuring bar, the positioning of the central ball is completed;
wherein, in the motion measuring step, the central ball is driven to move by at least one of the other two of the three axes.

16. A motion measurement system, which is applied to measure a motion trajectory of a machine, comprising:
a central rod installed on a main spindle of the machine;
a central ball connected to one end of the central rod, wherein a center of the central ball is defined as a motion measurement point;
a first reference socket and a second reference socket mounted on a worktable of the machine;
a first measuring ball attached to the first reference socket, wherein a first reference point is defined at a center of the first measuring ball;
a second measuring ball attached to the second reference socket, wherein a second reference point is defined at a center of the second measuring ball;
a first measuring bar connected between the first measuring ball and the central ball; and
a second measuring bar connected between the second measuring ball and the central ball;
wherein the central ball connected to the central rod is driven by the machine such that each of the first measuring bar and the second measuring bar is extended or shortened, and a coordinate of the motion measurement point and the motion trajectory of the machine are obtained according to a first measuring distance between the first reference point and the motion measurement point measured by the first measuring bar, and a second measuring distance between the second reference point and the motion measurement point measured by the second measuring bar, in association with a first reference distance between the first reference point and the second reference point.

17. The motion measurement system of claim 16, wherein at least one of the first measuring bar and the second measuring bar is used to measure the first reference distance.

18. The motion measurement system of claim 16, further comprising:
a transverse member connected to one end of the second measuring bar.

19. The motion measurement system of claim 18, wherein the transverse member comprises:
a connecting portion connected to the second measuring bar; and
a transverse socket connected to the central ball;
wherein an axis of the connecting portion is perpendicular to an axis of the transverse socket, or a known angle is contained between the axis of the connecting portion and the axis of the transverse socket.

20. The motion measurement system of claim 18, wherein the transverse member comprises a positioning portion, and the second measuring bar comprises an aligning portion engaged with the positioning portion.

21. The motion measurement system of claim 19, wherein the second measuring bar comprises a balance block.

22. The motion measurement system of claim 16, wherein the first measuring bar comprises a linear optical scale, a magnetic scale, a linear variable differential transformer or a laser interferometer, and the second measuring bar comprises another linear optical scale, another magnetic scale, another linear variable differential transformer or another laser interferometer.

23. The motion measurement system of claim 16, further comprising:
a third reference socket disposed on the worktable of the machine;
a third measuring ball attached to the third reference socket, wherein a third reference point is defined at a center of the third measuring ball; and
a third measuring bar connected between the third reference socket and the central ball;
wherein the coordinate of the motion measurement point and the motion trajectory of the machine are obtained according to a third measuring distance between the third reference point and the motion measurement point measured by the third measuring bar which is connected between the central ball and the third measuring ball, in association with the first measuring distance, the second measuring distance, the first reference distance, a second reference distance between the first reference socket and the third reference socket, and a third reference distance between the second reference socket and the third reference socket.
